(19) United States
(12) Patent Application Publication
(10) Pub. No.: US 2008/0110319 A1
(43) Pub. Date: May 15, 2008

(54) MUSICAL INSTRUMENT PLECTRUM

(76) Inventor: B. Scott Morris, New Castle, DE (US)

Correspondence Address: Connolly Bove Lodge & Hutz LLP, P.O. Box 2207, Wilmington, DE, 19899-2207, US

(21) Appl. No.: 11/560,043

(22) Filed: Nov. 15, 2006

(51) Int. Cl. G10D 3/16

(52) U.S. Cl. 84/320

(57) ABSTRACT

A musical instrument double plectrum is formed by providing a double coated adhesive spacer. A plate is adhesively detachably mounted to each side of the spacer so that each of the two plates functions as a plectrum. Preferably, the plates are mounted in a staggered fashion. A cutout is preferably formed in each plate to expose the adhesive and provide the player with a grip.

### BACKGROUND OF INVENTION

Plectrums are used in the playing of various string instruments. In order to enhance the quality of the music it is also known to provide a multiple plectrum such as a double plectrum. U.S. Pat. No. 5,253,562, for example, discloses a double plectrum having a spacer filled with compressible fluid. U.S. Pat. No. 5,594,189 discloses a tri-point plectrum wherein an intermediate pick portion extends outwardly a greater distance than the upper and lower portions.

### SUMMARY OF INVENTION

An object of this invention is to provide a musical instrument plectrum in the form of a double plectrum.

A further object of this invention is to provide such a double plectrum wherein the individual plectrums are detachably mounted to an intermediate spacer.

In accordance with this invention the spacer has a pair of adhesive coated sides. A first plate is detachably adhesively mounted to the first adhesive side of the spacer and a second plate is detachably adhesively mounted to the second adhesive side of the spacer so that both plates thereby form the individual plectrums of a double plectrum.

In a preferred embodiment of this invention each plate contains a cutout so that the adhesive on each side of the spacer is exposed through the cutout to provide the player with a grip.

Preferably, one of the plectrums extends outwardly a greater distance than the other plectrum so that the stagger give a chorus sound.

### THE DRAWINGS

FIG. 1 is a right side elevational view of a double plectrum in accordance with this invention;

FIG. 2 is a top plan view of the double plectrum shown in FIG. 1;

FIGS. 3-4 are rear and front elevational views of the double plectrum shown in FIGS. 1-2;

FIG. 5 is a bottom plan view of the double plectrum shown in FIGS. 1-4;

FIG. 6 is a side elevational view of one of the plates or plectrums used in the double plectrum shown in FIGS. 1-5;

FIG. 7 is a top plan view of the plectrum shown in FIG. 6;

FIG. 8 is a side elevational view, partly in section, of a spacer which can be used in the double plectrum of FIGS. 1-5;

FIG. 9 is a top plan view, partly broken away, of the spacer shown in FIG. 8; and

FIG. 10 is an end elevational view partly in section showing use of the double plectrum shown in FIGS. 1-5.

### DETAILED DESCRIPTION

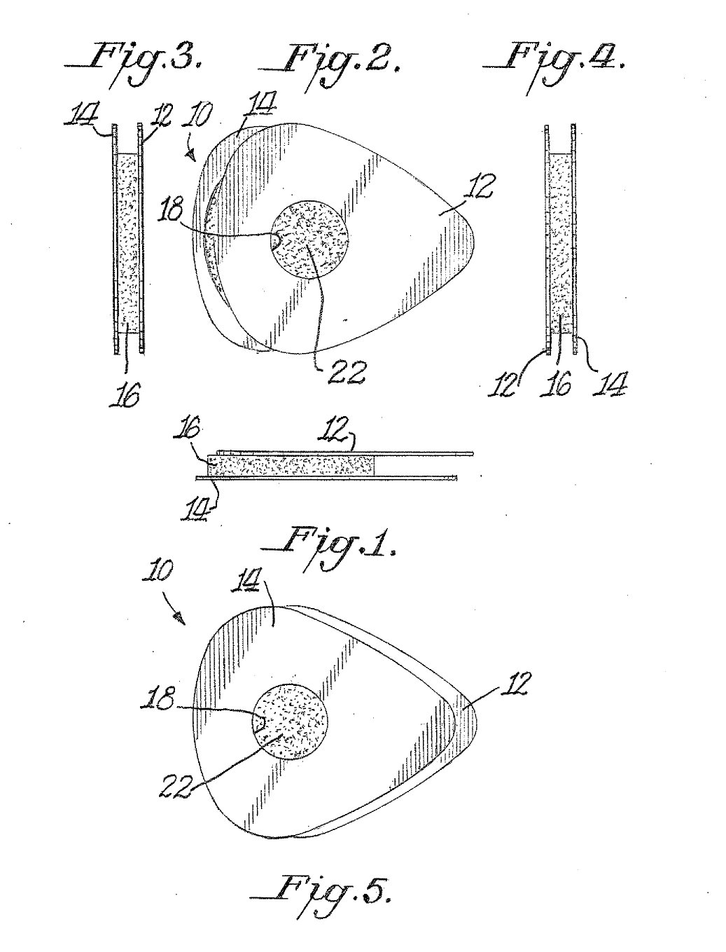

FIGS. 1-5 illustrate a musical instrument plectrum 10 in accordance with a preferred practice of this invention. As shown therein the plectrum 10 is a double plectrum which comprises three primary components, namely, a first plate 12, a second plate 14 and an intermediate spacer 16. Plates 12 and 14 are of generally tear-dropped shape and made of any suitable material conventionally used for musical instrument plectrums. Such material could, for example, be a suitable plastic material.

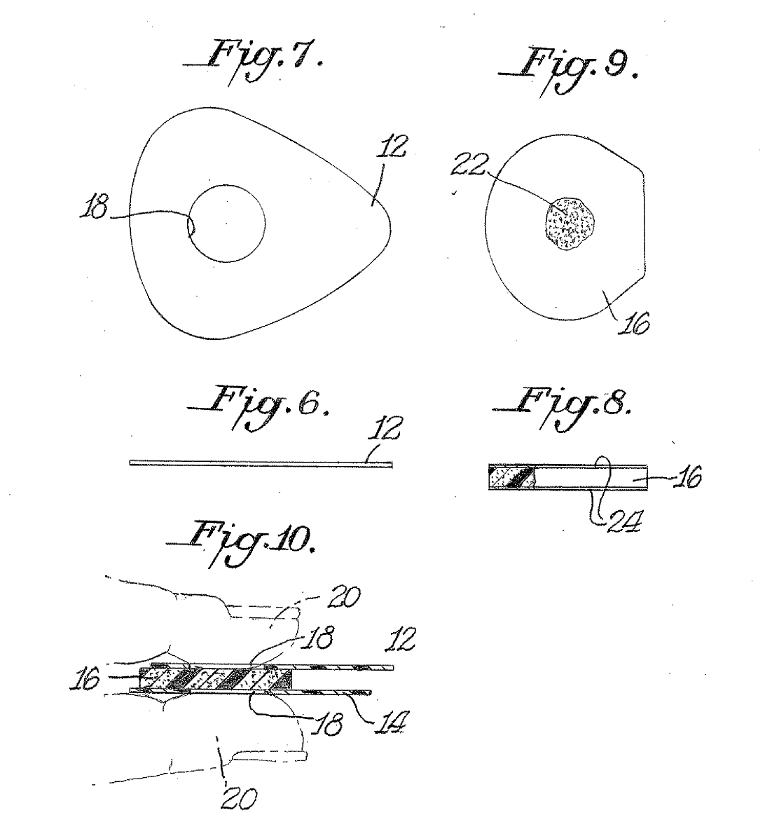

FIGS. 6-7 illustrate one of the plates 12. The other plate 14 could be of identical construction. As shown therein, plate 12 includes a cutout 18 which is located in the rear portion of the tear-dropped shape. In the illustrated form cutout 18 is a circular die-cut with an edge of the circle being located about midway between the two ends of the plate 12 so that the circular cutout itself is located in the rear portion of the double plectrum 10 where the double plectrum would be held between the fingers 20 of the player as shown in FIG. 10.

FIGS. 8-9 illustrate the spacer 16 which would be located between the plates 12,14. Plate 16 is made of any suitable material and preferably is a foam spacer having an adhesive coating 22 on each of its first and second sides against which the plates 12,14 would be located. As shown in FIG. 8 a removable protective layer or lines 24 may be disposed against each adhesive coated side of spacer 16 before the plates are mounted to the spacer so as to protect the adhesive coated surfaces.

The double plectrum 10 is assembled by providing a suitable pair of plates 12,14 of the desired materials, gauges or shapes. A suitable spacer 16 is selected which would be generally of the shape shown in FIG. 9 which is a frusto-tear-dropped shape generally conforming to the shape at the rear portions of the plates 12,14, but terminating significantly inwardly of the forward ends of the plates 12,14 so that the plates 12,14 at their forward ends are free to move as required for use as a plectrum. This is clearly shown in FIGS. 1 and 10. Although spacer 16 is preferably of generally the same shape as the rearward portion of each plate, spacer 16 is preferably made proportionally slightly smaller in size so that it does not extend at least to any significant degree outwardly beyond the edges of the plectrums or plates 12,14.

Once the protective layers 24,24 are removed from spacer 16 a respective plate 12 and 14 would then be attached to the spacer by being adhesively mounted to the spacer. In the preferred practice of this invention the plates 12,14 are mounted in a staggered fashion with one of the plates or plectrums extending forwardly beyond the other plate or plectrum. It is this stagger feature that gives the desired effect of creating a chorus sound. This is achieved by allowing, for example, the first or bottom plectrum 14 to hit the first string before the second or top plectrum 12. In one practice of this invention each plectrum is about 1.2 inches long at its greatest length and about 1 inch wide at its greatest width. The cutout 18 has a diameter of about 0.4 inches. Spacer 16 would have a thickness of ⅛ inch so that the surfaces of the plates or plectrums 12,14 disposed against spacer 16 are spaced that distance apart from each other. As noted above, an important feature in the preferred practice of this invention is that one of the plectrums extends forwardly of the other plectrum to help achieve a fuller sound with more resonance or chorus effect using either electric or acoustic instruments. The preferred distance of forward stagger is 0.100-0.125 inches.

By providing the cutouts 18 in the wide portions of the plectrums 12,14 the adhesive 22 is exposed to provide the player with a grip. See FIGS. 1, 5 and 10. Alternatively, instead of cutouts, gripping could be enhanced by ribs or other surface irregularities. Such gripping structure could be formed by hot stamping a logo onto one or both plectrums in the general location shown by the cutouts.

A further advantage of using an adhesive coated spacer is to provide the player with freedom to interchange plectrums of various materials, gauges or shapes.

The invention is particularly intended to provide a double plectrum. The invention may also be practiced with a second spacer and a third plectrum to create a triple plectrum although this is not as preferred as a double plectrum. Similarly, even more than three plectrums with the appropriate number of spacers could be used in the broad practice of this invention.

1. A musical instrument plectrum comprising a first plate to function as a first plectrum, a second plate to function as a second plectrum, a spacer having a first side and an opposite second side, said first plate being mounted to said first side of said spacer, said second plate being mounted to said second side of said spacer, and said first plate and said second plate being separate and distinct from each other whereby each of said first plate and said second plate may be separately mounted to and removed from said spacer, and said plates being mounted in a staggered manner whereby said first plate extends forwardly away from said spacer a greater distance than said second plate.

2. The plectrum of claim 1 wherein at least one of said plates includes gripping structure to provide the player with a grip.

3. (canceled)

4. The plectrum of claim 2 wherein said first plate extends forwardly of said second plate a distance in the range of 0.100-0.125 inches.

5. The plectrum of claim 2 wherein said spacer is made from a foam material.

6. The plectrum of claim 1 wherein each of said plates is of generally tear-dropped shape having a wide portion at one end thereof and a generally pointed portion at the other end thereof

7. The plectrum of claim 6 wherein a cutout is in each of said plates located in said wide portion.

8. (canceled)

9. The plectrum of claim 1 wherein said first plate extends forwardly of said second plate a distance in the range of 0.100-0.125 inches.

10. The plectrum of claim 1 wherein said spacer is made from a foam material.

11. A method of forming a musical instrument plectrum comprising providing a spacer having a first side and a second side, mounting a first plate to the first side of the spacer to form a first plectrum, mounting a second plate to the second side of the spacer to form a second plectrum, and mounting the plates to the spacer in a staggered fashion whereby one of the plates extends forwardly of the spacer a great distance than the other of the plates.

12. The method of claim 11 including providing gripping structure for at least one of the plates to provide the player with a grip.

13. The method of claim 19 wherein each side of the spacer has an adhesive coating, and including providing a protective liner against each adhesive coated side of the spacer and then removing the protective liner before the respective plates are adhesively mounted to the spacer.

14. (canceled)

15. The method of claim 13 including removing at least one of the plates and replacing that removed plate with a further plate.

16-17. (canceled)

18. The method of claim 11 including removing at least one of the plates and replacing that removed plate with a further plate.

19. The method of claim 11 including adhesively mounting each of the plates to the spacer.

20. The method of claim 11 including detachably mounting each of the plates to the spacer.

21. The method of claim 11 including forming a cutout in each plate to expose the spacer for facilitating the gripping of the plectrum.

22. The method of claim 21 wherein the spacer is made from a foam material to comprise a gripping surface through the cutouts.

23. The plectrum of claim 1 wherein each of said plates is adhesively mounted to said spacer.

24. The plectrum of claim 1 wherein each of said plates is detachably mounted to said spacer.
